(19) United States
(12) Patent Application Publication
(10) Pub. No.: US 2011/0016842 A1
(43) Pub. Date: Jan. 27, 2011

(54) METHOD FOR PRODUCING DYED SEWING THREADS

(75) Inventors: Heinz Kägi, Saland (CH); Michael Stabenow, Gutach (DE)

Correspondence Address: AMSTER, ROTHSTEIN & EBENSTEIN LLP, 90 PARK AVENUE, NEW YORK, NY, 10016, US

(73) Assignee: GÜTERMANN & CO. AG, Zurich (CH)

(21) Appl. No.: 12/667,635

(22) PCT Filed: Jun. 24, 2008
(86) PCT No.: PCT/EP2008/005104

§ 371 Date: Jun. 29, 2010

(30) Foreign Application Priority Data
Jul. 4, 2007 (DE) 102007031037.6

(51) Int. Cl. D02G 3/40; D02G 3/00; D02G 3/36; B05D 3/12

(52) U.S. Cl. 57/258; 428/375; 428/391; 427/177; 156/148

(57) ABSTRACT

The invention relates to a method for producing dyed sewing threads, especially airbag threads. According to said method, a preparation improving the thread properties and a dye are applied to the thread, the preparation and the dye being mixed and being applied jointly to the thread as a mixture. The invention also relates e.g. to a sewing thread produced according to said method.

The invention relates to a method for manufacturing dyed sewing threads, in particular airbag threads, wherein both a preparation improving the thread properties and a dye are applied to the thread.

Dyed sewing threads are used, on the one hand, for the manufacture of textiles, but, on the other hand, also for special applications such as for the sewing of airbags. The threads used for the sewing of airbags are dyed, on the one hand, to give the threads a manufacturer's identification; on the other hand, the coloring serves for the production of a contrast in the region of a finished seam so that it can be examined for freedom of faults more easily.

Threads of the named kind are furthermore usually provided with a special preparations (or also “finishing” or “softener”) which determines or improves the sewing properties of the thread. Depending on the application, different preparations are used which have, for example, effects on the sliding properties, the abrasion resistance or the static charge of the thread.

In usual methods for manufacturing dyed sewing threads provided with a preparation, the threads are first wound onto dye bobbins which are then supplied to a dye bath in which the dye bobbins remain for a specific time until the threads have been given the desired color. After the end of the dyeing process, the respective desired preparation is then applied to the dyed threads by means of a suitable preparation process, with it being necessary for the carrying out of such preparation processes to re-reel the thread from the dye bobbin onto a further bobbin so that the preparation can be applied directly in the region between both bobbins.

It is an object of the invention to improve a method of the initially named kind such that it can be carried out with a reduced economic effort.

This object is satisfied in accordance with the invention in that the preparation and the dye are mixed and are subsequently applied together to the thread as a mixture.

The process of dyeing is so-to-say integrated into the preparation process by this surprisingly simple measure so that previously usual time-consuming dyeing processes can be practically completely dispensed with, whereby the cost-effectiveness of the manufacture is significantly increased. In this respect, within the framework of the invention, it is intentionally accepted that, on the application of a preparation mixed with a dye, a reproducible and uniform dyeing of the thread is not achieved in every case such as is usually required for the manufacture of textiles. It was namely recognized in accordance with the invention that is does not play any role in specific applications, in particular in the production of airbag threads, whether a color shade is achieved exactly and can be produced reproducibly. It is rather sufficient in the manufacture of airbag threads if a specific color can only be recognized qualitatively, with it not being necessary beyond this that the color is distributed uniformly over the length of the thread prior to the sewing procedure.

On the testing of the invention, it furthermore resulted that, on the sewing of a thread dyed non-uniformly in accordance with the invention, a homogenization of the color is effected over the length of the thread by the friction between the thread and the material to be sewed in that the dye is “smeared” along the thread during the sewing procedure. After the sewing procedure, the thread therefore has a substantially uniform coloring over its total length due to the named “smearing” so that the quality of a produced seam can be checked without problem with reference to contrast differences between the thread and the sewed material over the total length of the thread.

In addition, it can also be achieved with a thread dyed non-uniformly in accordance with the invention that the applied dye is recognizable as a manufacturer's identification before the sewing procedure since no uniform distribution of the dye over the length of the thread is necessary for such a recognition.

It is preferred if a twisting process takes place before the application of the mixture of preparation and dye since only twisted threads are in particular used as a rule for the manufacture of airbag threads.

A bonding of the twisted thread components can take place before the application of the mixture. Within the framework of such a bonding, two to three initial twists can, for example, be twisted with one another, with a hot melt adhesive thread being introduced between the initial twists during the twisting process. Subsequently, a heating of the hot melt adhesive thread then takes place so that it is spread in liquefied form between the twisted initial twists and bonds them to one another. It is thus prevented that a twisted thread can untwist again during the sewing procedure.

When the twisted thread components (initial twists) are bonded to one another, the method in accordance with the invention has a particularly advantageous effect since it occurred time and time again in processes known from the prior art that the named bonding loosened again on the introduction of the thread wound onto a dye bobbin into a dye bath so that costly production downtimes occurred on the sewing of airbags with improperly bonded airbag threads. Such problems can be precluded in accordance with the invention since it is no longer necessary to introduce the bonded threads into a dye bath.

As already mentioned, it is therefore advantageous to apply the mixture of preparation and dye to the thread in a process free of a dye bath, with this application preferably taking place during a re-reeling process. Such a re-reeling process can be carried out, for example, at a speed of up to 1000 m/min. The method in accordance with the invention can in this manner be carried out in an economically advantageous manner in an extremely short time.

It is particularly preferred if the thread is immediately wound onto a fully wound bobbin (final presentation) by means of the named re-reeling process so that it is already present in a form ready for sale after carrying out the re-reeling process.

The mixture of preparation and dye can be applied to the thread by means of a metering system, in particular by means of a sponge applicator. In this respect, the mixture is in particular continuously supplied to the sponge so that it can be applied from the sponge to the thread as uniformly as possible.

Within the framework of such a metering system, the thread preferably first runs through an application region and subsequently through a homogenization region following it in the conveying direction. Within the framework of the application region, the mixture of preparation and dye is applied to the thread, whereupon a homogenization of the applied mixture over the length of the thread running through is produced in the homogenization region at least up to a specific degree.

Alternatively to the named metering system, the mixture of preparation and dye can also be applied to the thread via a godet dipping at least regionally into a godet bath.

Both the named metering system and the named godet bath will be explained in even more detail within the framework of the description of the Figures.

It is particularly advantageous if such a quantity of mixture is applied to the thread that the weight of the mixture amounts to 4% to 8%, in particular to approximately 6%, of the total weight of the finished thread. Such threads are particularly suitable for the manufacture of airbags.

It is permissible within the framework of the invention that the dye and the preparation are only mixed before the application of the mixture to the thread such that the dye has not fully dissolved in the preparation. This then has the consequence that the preparation is admittedly applied to the thread relatively uniformly by means of the metering system or the godet bath, but no uniform dyeing of the thread can be achieved due to the incomplete dissolving of the dye in the preparation. A thread dyed with such a mixture can therefore, for example, have a specific irregular color pattern, with it nevertheless being possible without problem to recognize the respective color which can serve for the identification of a manufacturer. As already explained, a homogenization of the color over the length of the thread (“smearing”), however, subsequently in the sewing procedure so that the quality examination of the seams produced is not impaired.

The preparation used within the framework of the invention can contain, for example, silicones, paraffins, waxes, emulsions and/or antistatic agents. The use of additional components not explicitly listed here is also possible.

It is particularly preferred if the mixture used in accordance with the invention contains a dye which is suitable for the dyeing of waxes or oils. Such dyes dissolve comparatively well and uniformly in a preparation. The threads used for the method described are preferably made of polyamide, polyester, polypropylene, aromatic polyamides, polyacrylonitrile, polytetrafluoroethylene or polyethylene.

The invention furthermore relates to a sewing thread, in particular to an airbag thread, having a preparation improving the thread properties and a dye, with the outermost layer of the sewing thread being formed by a mixture of the preparation and of the dye. Such a thread can preferably be manufactured by a previously described method. It differs from threads in accordance with the prior art in that it does not have any uniform “permanent coloring” over the total cross-section of the thread. In addition, the thread in accordance with the invention does not have any color-free preparation as the outermost layer, but rather an outermost layer in which both the preparation and the dye are present.

It is preferred if the named outermost layer is only dyed regionally by the dye, with this essentially relating to the state of the thread before the sewing procedure. The explained “smearing” of the dye is effected by the sewing procedure so that a substantially complete dyeing of the outermost layer is then present in the sewn thread.

Further preferred embodiments of the invention are set forth in the dependent claims.

The invention will be described in the following with reference to embodiments and to the drawings; there are shown:

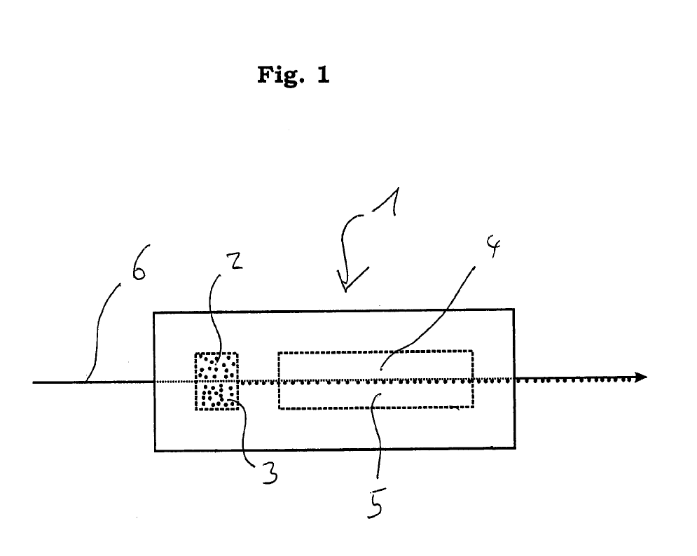

FIG. 1 a schematic representation of a metering system which is suitable for the application of the mixture in accordance with the invention; and

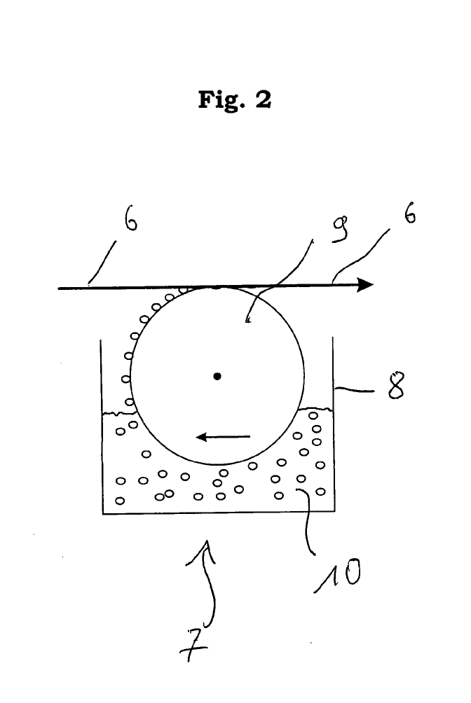

FIG. 2 a schematic representation of a godet bath which likewise has the named function.

FIG. 1 shows a metering system 1 through which a thread 6 is moved from left to right within the framework of a re-reeling process. The metering system 1 has an application region comprising two sponge halves 2, 3 and a homogenization region which follows it in the conveying direction of the thread and which is formed by two sponge halves 4, 5.

The two sponge halves 2, 3 are supplied continuously, in a manner not shown in more detail, with a mixture of preparation and dye. When the thread 6 is moved between the two sponge halves 2, 3, a still relatively non-uniform layer arises along the outer periphery of the thread 6 which is formed by the mixture of preparation and dye.

Subsequently, the thread bearing the named layer is pulled between the two sponge halves 4, 5 which are not supplied with mixture. The sponge halves 4, 5 serve only to homogenize the mixture already present on the thread surface. In this respect, the two sponge halves 4, 5 have a much larger extent in the transport direction of the thread 6 than the two sponge halves 2, 3 of the application region. The extent of the sponge halves 4, 5 in the named direction in particular amounts to 3 to 7 times the extent of the sponge halves 2, 3 in the corresponding direction.

As a rule, at least a uniform application of the preparation on the thread surface is achieved by the sponge halves 4, 5. If the dye is not uniformly dissolved in the preparation, a homogenization of the dye in the outermost layer of the thread 6 only takes place by the sewing procedure.

FIG. 2 shows a godet bath 7 with a godet tub 8 into which a godet 9 rotatable about an axis dips regionally. The godet tub 8 is filled to approximately half with a mixture 10 of preparation and dye. A thread 6 is wound simply or multiply around the godet 9 during the carrying out of the method in accordance with the invention.

If now the thread 6 is guided over the godet within the framework of a re-reeling process, it is ensured that the thread is dipped once or several times in dependence on the number of godet windings over its total length into the mixture 10 so that a layer of preparation and dye is produced at the surface of the thread 6 by this temporarily occurring dipping process.

The invention also includes methods in which a thread runs through a plurality of sequentially connected metering systems in accordance with FIG. 1 or through godet baths in accordance with FIG. 2. A combination of metering systems and godet baths is generally also conceivable.

### REFERENCE NUMERAL LIST

1 metering system
2 sponge half
3 sponge half
4 sponge half
5 sponge half
6 thread
7 godet bath
8 godet tub
9 godet
10 mixture

1-22. (canceled)

23. A method for manufacturing dyed sewing threads (6), in particular airbag threads, wherein both a preparation improving the thread properties and a dye are applied to the thread (6); and wherein the preparation and the dye are mixed and are subsequently applied together to the thread as a mixture (10), characterized in that
the mixture (10) is applied to the thread (6) by means of a metering system (1), in particular by means of a sponge applicator (2, 3); and in that the thread (6) runs in the metering system (1) through an application region (2, 3) and a homogenization region (4, 5) following it in the conveying direction.

24. A method in accordance with claim 23, characterized in that a twisting process and in particular a bonding of the twisted thread components takes place before the application of the mixture (10).

25. A method in accordance with claim 23, characterized in that the mixture (10) is applied to the thread (6) in a process free of a dye bath.

26. A method in accordance with claim 23, characterized in that the mixture (10) is applied to the thread (6) during a re-reeling process, in particular with the re-reeling process being carried out at a speed of up to 1000 m/min.

27. A method in accordance with claim 23, characterized in that such an amount of mixture (10) is applied to the thread (6) that the weight of the mixture (10) amounts to 4% to 8%, in particular to approximately 6%, of the total weight of the finished thread (6).

28. A method in accordance with claim 23, characterized in that the dye and the preparation are mixed such that the dye is not completely dissolved in the preparation.

29. A method in accordance with claim 23, characterized in that the preparation contains silicones, paraffins, waxes, emulsifiers and/or antistatic agents; and/or in that the mixture (10) contains a dye which is suitable for the dyeing of waxes or oils.

30. A method in accordance with claim 23, characterized in that the thread (6) is made of polyamide, polyester, polypropylene, aromatic polyamides, polyacrylonitrile, polytetrafluoroethylene or polyethylene.

31. A method for manufacturing dyed sewing threads (6), in particular airbag threads, wherein both a preparation improving the thread properties and a dye are applied to the thread (6); and wherein the preparation and the dye are mixed and are subsequently applied together to the thread as a mixture (10), characterized in that
the mixture (10) is applied to the thread (6) via a godet (9) at least regionally dipping into a godet bath (7).

32. A method in accordance with claim 31, characterized in that a twisting process and in particular a bonding of the twisted thread components takes place before the application of the mixture (10).

33. A method in accordance with claim 31, characterized in that the mixture (10) is applied to the thread (6) in a process free of a dye bath.

34. A method in accordance with claim 31, characterized in that the mixture (10) is applied to the thread (6) during a re-reeling process, in particular with the re-reeling process being carried out at a speed of up to 1000 m/min.

35. A method in accordance with claim 31, characterized in that such an amount of mixture (10) is applied to the thread (6) that the weight of the mixture (10) amounts to 4% to 8%, in particular to approximately 6%, of the total weight of the finished thread (6).

36. A method in accordance with claim 31, characterized in that the dye and the preparation are mixed such that the dye is not completely dissolved in the preparation.

37. A method in accordance with claim 31, characterized in that the preparation contains silicones, paraffins, waxes, emulsifiers and/or antistatic agents; and/or in that the mixture (10) contains a dye which is suitable for the dyeing of waxes or oils.

38. A method in accordance with claim 31, characterized in that the thread (6) is made of polyamide, polyester, polypropylene, aromatic polyamides, polyacrylonitrile, polytetrafluoroethylene or polyethylene.

39. A sewing thread, in particular an airbag thread, having a preparation improving the thread properties and a dye, wherein the outermost layer of the thread (6) is formed by a mixture of the preparation and of the dye, characterized in that the outermost layer is only regionally dyed by the dye.

40. A sewing thread in accordance with claim 39, characterized in that the preparation contains silicones, paraffins, waxes, emulsifiers and/or antistatic agents; and/or in that the mixture (10) contains a dye which is suitable for the dyeing of waxes or oils.

41. A sewing thread in accordance with claim 39, characterized in that the thread (6) is made of polyamide, polyester, polypropylene, aromatic polyamides, polyacrylonitrile, polytetrafluoroethylene or polyethylene.

42. A sewing thread in accordance with claim 39, characterized in that the thread (6) is made as ply yarn.

43. A sewing thread in accordance with claim 23, characterized in that the twisted thread components are bonded.
